(19) United States
(12) Patent Application Publication
(10) Pub. No.: US 2025/0378329 A1
(43) Pub. Date: Dec. 11, 2025

(54) Invertible Fused Tokenization of Multiple Encoders

(71) Applicant: Google LLC, Mountain View, CA (US)

(72) Inventors: Aren Jansen, Mountain View, CA (US); Hakan Erdogan, Lexington, MA (US); Matthew Richard Augustus Harvey, Dublin, CA (US)

(21) Appl. No.: 19/235,099

(22) Filed: Jun. 11, 2025

Related U.S. Application Data
(60) Provisional application No. 63/658,657, filed on Jun. 11, 2024.

(51) Int. Cl. G06N 3/08; G06N 3/045

(52) U.S. Cl. CPC G06N 3/08; G06N 3/045

(57) ABSTRACT

Methods and systems for one or more computers, in which a method includes obtaining encoding sequences of an input data item, in which each encoding sequence includes a respective encoding vector at each position of multiple positions. The method includes generating a combined encoding sequence by, at each position, combining the respective encoding vectors at the position in the multiple of encoding sequences. The method includes processing the combined encoding sequence using a deduplicator neural network to generate a deduplicated encoding sequence that includes a respective deduplicated encoding vector for each of the positions and applying a tokenizer to the deduplicated encoding sequence to identify, for each deduplicated encoding vector, a discrete representation of the deduplicated encoding vector generated from respective codebook vectors from each of a set of one or more codebooks, in which each codebook is a respective discrete set of codebook vectors.

### CLAIM OF PRIORITY

This application claims priority under 35 USC § 119 (e) to U.S. Patent Application Ser. No. 63/658,657, filed on Jun. 11, 2024, the entire contents of which are hereby incorporated by reference.

### BACKGROUND

This specification relates to training neural networks for generating encoding sequences. Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

Many neural networks such as large language models process encoded versions of an input data item. For example, a large language model can process an encoding sequence, where the encoding sequence is a numerical representation of a text data item (i.e., a query from a user).

### SUMMARY

This specification describes a system implemented as computer programs on one or more computers in one or more locations that trains a neural network to process a set of multiple encoding sequences to generate a discrete representation of the combined multiple encoding sequences. Each encoding sequence corresponds to a modality or domain of a single data source. For example, a first encoding sequence can correspond to a music component of an audio representation of a scene, and a second encoding sequence can correspond to a text-based description of the same scene. Each encoding sequence includes a sequence of encoding vectors. Each encoding sequence that corresponds to a unique domain or modality includes an encoding vector for each time step of the single data source, e.g., of the scene.

Encoding neural networks, e.g., encoders, process input data, e.g., audio data, to generate a representative sequence of encoding vectors. In some cases, an encoder that is trained to generate an encoding sequence from a music component of audio data performs better, e.g., it can be more accurately decoded to represent the original data, than an encoder that is trained for a generic use case or for a different specific use case. The multiple encoders for each domain and/or modality of a particular data source leads to multiple encoding sequences that, when considered together, represent the original data source better than a single encoding sequence that represents all domains and modalities simultaneously.

In some cases, the information contained in each encoding sequence has an amount of redundancy with one or more other encoding sequences. For example, a first encoding sequence that represents an audio-based dialogue component of a scene and a second encoding sequence that represents a text-based dialogue component of the scene can have some degree of redundancy. The redundancy between encoding sequences leads to a larger than necessary encoded representation of the original data source that represents the dialogue of the scene.

The system combines the multiple encoding sequences corresponding to multiple modalities and/or domains of a single data source. One or more trained neural networks process the combined encoding sequences to generate a quantized and deduplicated encoded representation of the combined encoding sequences.

Particular embodiments of the subject matter described in this specification can be implemented so as to realize one or more of the following advantages.

The system combines and processes multiple encoding sequences generated by specialized encoders for each domain and/or modality, which ensures an optimal encoded representation of each. By training neural networks to remove redundancies between the multiple encoding sequences and generating a single discrete representation of the multiple encoding sequences, the system generates a single, efficient (e.g., low bitrate) encoding sequence that contains information to reconstruct the original encoding sequences. An efficient and accurate encoded representation of an input data source that includes multiple domains and modalities can be processed downstream by other systems, e.g., large language models, or efficiently stored for later reconstruction. For example, an encoded representation of audio data is a compressed representation of the audio data that can be stored in a memory device for later reconstruction.

In a first aspect, a method performed by one or more computers includes obtaining multiple encoding sequences of an input data item. Each encoding sequence includes a respective encoding vector at each position of multiple positions. The method includes generating a combined encoding sequence by, at each position, combining the respective encoding vectors at the position in the more than one encoding sequences. The method includes processing the combined encoding sequence using a deduplicator neural network to generate a deduplicated encoding sequence that includes a respective deduplicated encoding vector for each of the positions. The method includes applying a tokenizer to the deduplicated encoding sequence to identify, for each deduplicated encoding vector, a discrete representation of the deduplicated encoding vector generated from respective codebook vectors from each of a set of one or more codebooks, in which each codebook is a respective discrete set of codebook vectors.

In some implementations, the method includes generating a tokenized sequence that identifies, for each deduplicated encoding vector, the respective codebook vectors from the set of one or more codebook vectors used to generate the discrete representation of the deduplicated encoding sequence.

In some implementations, for each deduplicated encoding vector, the tokenized sequence includes a respective identifier for each of the respective codebook vectors from the set of one or more codebook vectors used to generate the discrete representation of the deduplicated encoding vector.

In some implementations, the method incudes providing the tokenized sequence as input to a generative neural network for generation of an output data item.

In some implementations, the method includes compressing the tokenized sequence to generate compressed data and storing the compressed data as a compressed representation of the input data item.

In some implementations, the method includes generating a detokenized sequence that includes the respective quantized representations of each of the deduplicated encoding vectors and processing the detokenized sequence using a reduplicator neural network to generate a reconstruction of the combined encoding sequence.

In some implementations, the method includes training the reduplicator neural network and the deduplicator neural network on a loss function that includes a reconstruction loss that measures an error between the combined encoding sequence and the reconstruction of the combined encoding sequence.

In some implementations, the reconstruction loss includes a respective reconstruction term for each encoding sequence that measures an error between the encoding sequence and a portion of the reconstruction of the combined encoding sequence that corresponds to the encoding sequence.

In some implementations, each reconstruction term measures a respective normalized reconstruction loss to correct for variations in scale of the one or more encoding vectors. In some implementations, the reconstruction loss is a weighted sum of the respective reconstruction terms, and in which two or more of the reconstruction terms have different weights in the weighted sum.

In some implementations, the method includes updating the one or more codebooks on a quantization loss function. In some implementations, the method includes applying a respective reconstruction loss for each encoding vector, wherein the respective reconstructive loss depends on the relative importance of the respective encoding vector.

In some implementations, the input data item includes multiple modalities of data, and the multiple sequences include a respective encoding sequence for each of the multiple modalities. In some implementations, combining the respective encoding vectors includes combining the respective encoding vectors at the position in the multiple encoding sequences.

In some implementations, the method includes generating each encoding sequence using a respective encoding neural network.

In a second aspect, a system including one or more computers and one or more storage devices storing instructions that when executed by the one or more computers cause the one more computers to perform the operations of the first aspect and the implementations described above.

In a third aspect, one or more computer readable storage media storing instructions that when executed by one or more computers cause the one more computers to perform the operations of the first aspect and the implementations described above.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example neural network training system and neural network inference system.

FIG. 2 is a diagram of an example neural network training system.

FIG. 3 is a flow diagram of a process of converting multiple encoding sequences into a discrete representation of a combined encoding sequence.

FIG. 4 is a flow diagram of a process of training a neural network.

Like reference numbers and designations in the various drawings indicate like elements.

### DETAILED DESCRIPTION

This specification describes a system implemented as computer programs on one or more computers in one or more locations that generates a tokenized representation of multiple encoding sequences characterizing an input data item.

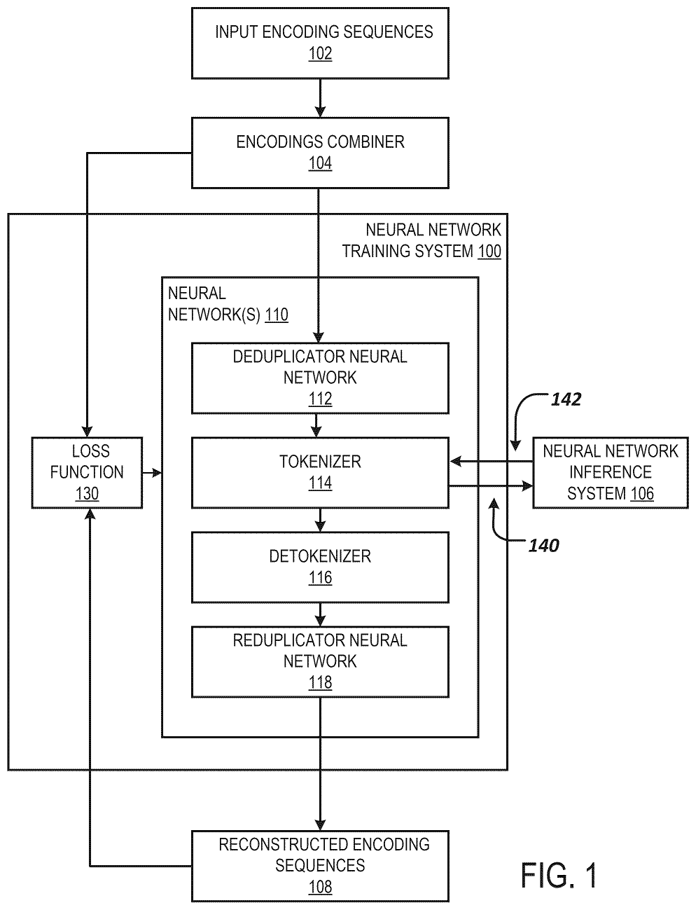

FIG. 1 shows an example neural network training system 100 and an example neural network inference system 106. The neural network training system 100 and the neural network inference system 106 are examples of systems implemented as computer programs on one or more computers in one or more locations, in which the systems, components, and techniques described below can be implemented.

The neural network training system 100 trains a set of neural networks 110 to receive as input a set of multiple input encoding sequences 102 and to process the set of input encoding sequences 102 to generate a reconstructed encoding sequence 108. In addition, a subset of the set of neural networks 110 generates an intermediate discrete and deduplicated representation of the multiple input encoding sequences 102, as described below. The discrete and deduplicated representation can be processed by the neural network inference system 106, efficiently stored for later reconstruction, or processed by other downstream applications.

One or more encoders, i.e., encoding neural networks, generate each of the respective input encoding sequences 102 from the same input data item. Each input encoding sequence 102 includes a respective encoding vector at each of multiple positions, where an encoding vector is a numerical representation of the input data item that can be processed by a neural network. In other words, each input encoding sequence 102 has the same number of positions and includes a respective encoding vector at each of the positions.

For example, the input data item can be a data item of a particular modality, e.g., audio or video, and each of the input encoding sequences 102 can be generated by processing the input data item using a different encoder.

As a specific example, each of the input encoding sequences 102 can relate to the same audio input data item. In this example, the input encoding sequences 102 can include a first encoding sequence corresponding to the dialogue portion of the audio input data item, a second encoding sequence corresponding to the environmental portion of the audio input data item, and a third encoding sequence corresponding to the music portion of the audio input data item.

In some implementations, a unique encoder generates an encoding sequence for each domain (i.e., the dialogue audio, the environmental audio, and the music audio). Each encoder is specifically designed, e.g., trained, to process and represent the unique characteristics of the domain. That is, in some cases, data corresponding to different domains can exhibit different temporal characteristics (i.e., sporadic sounds from doors creaking and birds chirping vs. a predictable sequence of sounds from a music soundtrack), and the process of encoding data from each domain may require an encoder that is optimized and trained for each specific domain.

As another example, the input data item can be a multi-modal data item, i.e., that includes multiple different modalities of data, and a unique encoder can generate each of the respective input encoding sequences 120. For example, a video input data item can include an audio component, a sequence of images that correspond to the frames of the video, and a text description of the dialogue in the video. A set of encoders, each specifically designed to represent the input data item for a corresponding modality, can generate the encoding sequences 102 for each modality and/or domain of the input data item. Other examples include an input data item that includes a sequence of images and a corresponding text transcript, audio data and a corresponding transcript, and an image of a scene and a corresponding point cloud that characterizes the same scene.

In some implementations, given the ability of specific encoders to represent the input data item of each domain and modality better than a general encoder or an encoder configured for a different domain or modality, the input of the neural networks 110 is a combination of the individual input encoding sequences 102 for each domain or modality extracted from a single data item. In other words, a specific encoder that may be trained for a specific domain or modality generates each corresponding encoding sequence for the input data item.

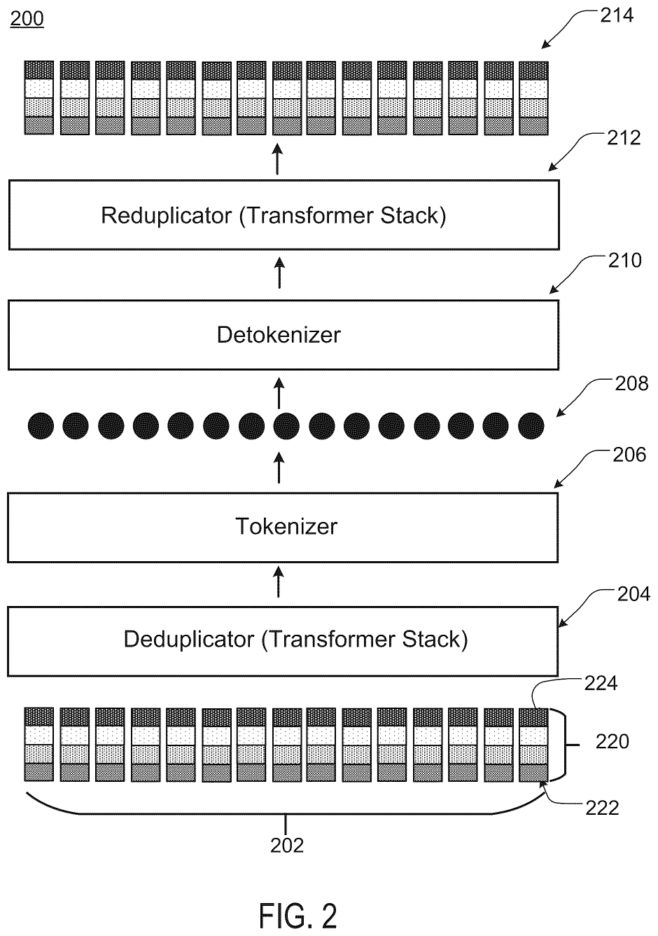

A combiner 104 combines (e.g., stacks) the encoding vectors at each position of the encoding sequences. The neural networks 110 process a resulting single combined encoding sequence that includes the sequence of stacked encodings. The details of how the encodings combiner 104 performs the sequence combination along with examples are discussed further in relation to FIG. 2.

In particular, the system 100 trains the neural networks 110 so that the neural networks 110 can generate a discrete and deduplicated representation of the set of input encoding sequences 102. In some cases, the discrete representation includes a sequence of identifiers (i.e., integers) and associated vectors. In some implementations, the sequence of identifiers and associated vectors are stored and indexed in a codebook. In general, the codebook includes a discrete set of codebook vectors that are indexed by a respective identifier.

Because of the way that the system 100 trains the neural networks 110, the discrete representation of the input encoding sequences 102 more efficiently (i.e., with a lower bitrate and/or token rate) represents the input data item compared to the input encoding sequences 102 while retaining enough information to at least partially reconstruct the input encoding sequences 102 with a corresponding detokenizer 116.

In more detail, the set of neural networks 110 includes a deduplicator neural network 112. The system 100 configures the deduplicator neural network 112 to remove redundancies, e.g., repetitive information between encoding sequences, from a combined encoding sequence. The deduplicator neural network 112 processes the combined encoding sequence from the encodings combiner 104 and generates a single deduplicated encoding sequence. In some implementations, the single deduplicated encoding sequence has the same dimensionality as the combined encoding sequence.

A tokenizer 114 processes the deduplicated encoding sequence to generate a discrete representation of the deduplicated encoding sequence. In some implementations, the tokenizer 114 uses a codebook (i.e., a pre-defined set of encoding vectors), to identify a codebook vector for each encoding vector of the deduplicated encoding sequence. The codebook includes a list of vectors and their corresponding token values (token IDs). Each entry in the codebook pairs a codebook vector with a token value. The output of the tokenizer 114 is a sequence of tokens (e.g., a discrete representation), in which each token corresponds to a unique codebook vector.

The set of neural networks 110 also includes a reduplicator neural network 118. The system 100 configures the reduplicator neural network 118 to process the output of the detokenizer 116. The detokenizer 116 performs an inverse function of the tokenizer 114 by mapping the discrete representation of the combined encoding sequence to a reconstructed encoding sequence 108.

During training, the system 100 trains the reduplicator neural network 118 and the deduplicator neural network 112 on a loss function 130. In addition, the system 100 learns the vectors of the one or more codebooks used by the tokenizer 114 and the detokenizer 116.

The loss of information accumulated during transformation between the input encoding sequences 102 and the reconstructed encoding sequences 108 includes a combination of reconstruction loss and quantization loss. In some implementations, the reconstruction loss is due to the inability of the reduplicator neural network 118 to invert the transformation performed by the deduplicator neural network 112. The quantization loss is due to the choice of tokenization method and a degree to which the learned codebook vectors represent the input encoding vectors, as described in detail below in relation to FIG. 2. The loss function 130, which can evaluate both reconstruction loss and quantization loss, can be determined using the input encoding sequences and output reconstructed encoding sequences.

After training, the neural network inference system 106 can use some or all outputs of the neural networks in the set of neural networks 110 for any of a variety of purposes.

For example, the neural network inference system 106 can include a large language model. The large language model can process, e.g., through channel 140, the output of the tokenizer 114 as a sequence of tokens that represent text embeddings.

Alternatively, or in addition, a large language model can process an input, e.g., a text prompt or a multi-modal input, to generate a discrete encoding sequence, similar to the discrete encoding sequence generated by the tokenizer 114. The detokenizer 116 can process the discrete encoding sequence, e.g., through channel 142, generated by the large language model, to generate a corresponding reconstructed encoding sequence 108. The reconstructed encoding sequence 108 can then be used to generate a new data item, e.g., by using one or more decoder neural networks.

FIG. 2 illustrates a neural network training system 200. The system includes a deduplicator neural network 204 that processes a combined encoding sequence 202. The system 202 includes a tokenizer that processes an output of the deduplicator neural network 204, a reduplicator neural network 212 that processes the output of the tokenizer 206, a detokenizer 210 that processes an output of the tokenizer 206, and a reduplicator neural network 212 that processes an output of the detokenizer 210. The neural network training system 200 is an example of a system implemented as computer programs on one or more computers in one or more locations, in which the systems, components, and techniques described below can be implemented.

The combined encoding sequence 202 includes a sequence of vectors (e.g., vector 220). Each vector includes a combination of more than one encoding vectors (e.g., encoding vector 222 and encoding vector 224). An encodings combiner, e.g., the encodings combiner 104 of FIG. 1, combines (i.e., stacks) the encoding vectors at each position to generate the combined encoding sequence 202. FIG. 2 illustrates four encoding sequences combined into the single combined encoding sequence 202.

As described in relation to FIG. 1, in some implementations, a unique encoder generates each one of the four encoding sequences (e.g., the encoding sequence that includes encoding vector 222 and the encoding sequence that includes encoding vector 224) of the combined encoding sequence 202.

In more detail, for each domain and/or modality, a specialized encoder that can include supervised, self-supervised, semi-supervised, and weakly supervised neural networks, can generate an input encoding sequence to accommodate the specific characteristics of the input data item. For example, a general self-supervised audio encoding neural network (e.g., trained with BestRQ on audio data) will best support downstream speech understanding tasks only after fine-tuning with transcribed speech using an automatic speech recognition (ASR) objective. In comparison, BestRQ is a self-supervised learning approach for speech recognition. However, as with many encoders that are specifically designed for a particular domain, there is a tradeoff between the degree to which the encoder is specialized for the domain and the ability to transfer the encoder to operate in other domains. The general audio encoder trained with BestRQ on audio data demonstrates this tradeoff, where the audio encoder is unable to support non-ASR tasks such as text-to-speech (TTS) and speaker ID.

Similarly, nonspeech tasks involving music or general audio events pose a challenge for designing a single encoder for every domain. Speech is a highly structured and constrained audio signal with qualitatively different characteristics compared to door creaks and vehicle noise (e.g., environmental noise). As a result, in many cases, self-supervised general audio encoders trained on speech data behave differently than self-supervised general audio encoders trained on non-speech data. In particular, it as has been demonstrated that one dimensional temporal tiling works best for speech modeling and audio events are best served by two dimensional spectrotemporal tiling. (One dimensional temporal tiling includes analyzing an audio signal as a one-dimensional time series where the audio waveform is represented as a sequence of amplitude values over time. Two dimensional spectrotemporal tiling includes converting the audio signal into a spectrogram, which is a two-dimensional representation with time on one axis and frequency on the other. The intensity at each point in the spectrogram represents the energy of the audio signal at a specific frequency and time.) When reconstructing speech from specialized self-supervised speech encodings, the artifacts are higher level (i.e., phoneme substitutions like replacing “bat” with “cat” or replacing “run” with “sun”). When reconstructing speech from general audio encodings, lower-level acoustic artifacts are more prevalent. Despite the fact that each encoder is trained with the same self-supervised objective, the training domain (e.g., the data used to train the encoder) strongly influences the qualitative nature of the encoded representation of the input audio data.

A deduplicator neural network 204 processes the combined encoding sequence 202. The neural network training system 200 trains the deduplicator neural network 204 to remove redundancies in the combined encoding sequence 202. Because each encoding sequence (e.g., the encoding sequence that includes encoding vector 222) of the combined encoding sequence 202 represents the same data item, more than one encoding sequence can include duplicate information. The deduplicator neural network 204 can remove the redundant information without removing the information from the combined encoding sequence 202. For example, if a first encoding sequence (e.g., the encoding sequence that includes the encoding vector 222) corresponds to the dialogue audio of a video input data item and a second encoding sequence (e.g., the encoding sequence that includes the encoding vector 224) corresponds to a text transcription of the video input data item, the two encoding sequences will likely contain some of the same information. The system 200 trains the deduplicator neural network 204 to identify and remove the duplicated information between two or more complementary encoding sequences.

In some implementations, the deduplicator neural network 204 can include a stack of transformer layers. A stack of transformer layers can include one or more of a self-attention layer, a residual connection, a layer normalization function, a feed-forward layer, etc. The neural network training system 200 can configure the stack of transformer layers to remove redundances in the combined encoding sequence 202, similar to a data compression task or denoising task where a neural network model learns to identify and eliminate unnecessary or repetitive information. The output of the deduplicator neural network 204 is a single encoding sequence (e.g., a deduplicated encoding sequence) of the same dimensionality as the combined encoding sequence 202.

The neural network training system 200 trains a reduplicator neural network 212 to undo the transformation performed by the deduplicator neural network 204. The reduplicator neural network 212 generates a reconstructed combined encoding sequence 214. Similar to the deduplicator neural network 204, the reduplicator neural network 212 can include a stack of transformer layers. The neural network training system 200 can configure the stack of transformer layers to recover the redundancies that were removed by the deduplicator neural network 204 to reconstruct the original combined encoding sequence 202 while minimizing a reconstruction loss that measures an error between the combined encoding sequence 202 and the reconstruction of the combined encoding sequence 214.

The system 200 performs tokenization and detokenization between the operations performed by the deduplicator neural network 204 and the reduplicator neural network 212. A tokenizer 206 processes the output, e.g., a deduplicated encoding sequence, of the deduplicator neural network 204.

For each encoding vector of the deduplicated encoding sequence, the tokenizer 206 identifies a respective codebook vector from a set of one or more codebook vectors. The identified set of codebook vectors is a discrete representation 208 of the deduplicated encoding sequence. In some implementations, for each encoding vector of the deduplicated encoding sequence, the sequence includes a respective identifier (i.e., an integer) for each of the respective codebook vectors of the discrete representation 208.

In some implementations, the tokenizer 206 employs multiple codebooks to generate the discrete representation 208. In this case, the discrete representation 208 can be longer, e.g., include more encoding vectors, than the input deduplicated encoding sequence.

The neural network training system 200 applies a detokenizer 210 to the discrete representation 208. The detokenizer 210 identifies a respective sequence of codebook vectors from a sequence of identifiers of the discrete representation 208. The difference between the sequence of codebook vectors and the deduplicated encoding sequence represents a quantization loss in the system. Information is lost during the process of identifying a corresponding codebook vector for each encoding vector in the deduplicated encoding sequence. The set of codebook vectors that make up the codebook can be continuously learned to minimize the quantization loss during tokenization. In the case of multiple codebooks, the system 200 trains the detokenizer 210 to recover an encoding sequence of the same length as the deduplicated encoding sequence that is generated by the deduplicator neural network 204.

In more detail, the tokenizer 206 and the detokenizer 208 perform a pair of operations using methodologies including vector quantization, residual vector quantization (RVQ), product quantization (PQ) using entropy losses, and scalar binary quantization (SBQ).

In some implementations, the neural network training system 200 can skip the detokenizer 210 during training and send the identified codebook vectors directly to the reduplicator neural network 212. Since the detokenizer 210 converts the sequence of identifiers of the discrete representation 208 back to the sequence of codebook vectors, the detokenizer 210 is unnecessary if the set of identified codebook vectors is known.

Vector quantization is an approach that converts data represented in a continuous vector space to a representation in a discrete vector space. As previously described, in the case of tokenizing audio and video data, the tokenizer 206 can implement a codebook based on feature extraction. Key features of the data are extracted and clustered around a set of centroids which represent the entries in the codebook. In other words, any encoding represented by a vector in close proximity to a centroid vector in the vector space is mapped to the centroid vector. Vector quantization is a lossy process since encodings are approximated to be equal to the closest centroid vector. The difference between the encoding vector and the centroid vector (the centroid vector being a member of the set of discrete vectors indexed by the codebook) is not retained after the quantization occurs. The detokenization process includes converting the sequence of tokens back to an encoding sequence, in which each encoding is a member of the quantized set of encodings in the codebook, rather than the original vector that was quantized.

Residual vector quantization (RVQ) is a variation of vector quantization. The tokenizer 206 quantizes the input encodings in stages. For each stage, the tokenizer 206 encodes the residual error from a previous stage. For example, the tokenizer 206, using RVQ, first quantizes an encoding vector using a standard vector quantization approach and a first set of codebook vectors, as previously described. The tokenizer 206 determines a vector of residual values as the difference between each encoding vector and the corresponding quantized encoding vector. The residual vectors represent the information that is lost in the typical vector quantization process. In the case of RVQ, the tokenizer 206 quantizes the vectors of residuals using a second set of codebook vectors. The tokenizer 206 can repeat this process of quantizing the residuals iteratively until the residuals decrease below an adjustable threshold. The final representation of each quantized encoding vector is the sum of the quantized approximations from each stage. The quantized encodings using RVQ are more precise than quantized encodings using standard vector quantization because it takes the residual values and adds them back into the quantized encodings. The approach is more computationally expensive but is useful for applications that require high-precision quantized encodings like image and video compression where invertibility is a primary main objective.

Product quantization (PQ) includes splitting the space of encoding vectors into multiple subspaces and performing vector quantization in each subspace separately, allowing for a more compact representation of the encoding space. Considering a combination of entropy losses and product quantization ensures the respective codebooks for each subspace are optimized to minimize the redundancy in the compact representation of the encoding sequence. By minimizing the entropy losses, the quantization process attempts to use fewer vectors to represent the input encodings without losing information. When optimizing the codebooks for each subspace, there is a tradeoff between the quantization error (i.e., the residuals mentioned in relation to RVQ) and the entropy of the quantized vectors. Lower entropy implies higher quantization error, so the tokenizer 206 must find an optimal point that minimizes both parameters simultaneously. For example, in the case of data compression, using PQ and entropy losses ensures the compressed data uses the least number of possible bits while retaining as much of the original information as possible.

Scalar binary quantization (SBQ) is similar to vector quantization, but instead of mapping each input encoding vector to the closest quantized encoding vector in the codebook, the tokenizer 206 maps each input encoding vector to an integer value. The mapping is based on a similar clustering mechanism as standard vector quantization. In other words, the tokenizer 206 maps all encoding vectors that overlap in the high-dimensional space of encoding vectors to a shared integer value.

In some implementations, the tokenizer 206 uses a tokenization scheme that produces a quantized encoding sequence that is longer than the input encoding sequence, i.e., when multiple codebooks are used such as for RVQ (multiple codebooks, one for each stage of residuals) and PQ (multiple codebooks, one for each subspace). In this case, the system configures the detokenizer 210 to recover an encoded representation of the input data item with a sequence length equal to the input encoding sequence length.

In general, the system 200 trains the deduplicator neural network 204 and the reduplicator neural network 212 by minimizing the reconstruction loss between the combined encoding sequence 202 and the reconstruction of the combined encoding sequence 214. In some implementations, the system evaluates the reconstruction loss with a mean square error (MSE) between the input combined encoding sequence and the reconstruction of the combined encoding sequence. In general, the loss of information, e.g., the degree to which the system is not invertible, depends on both the reconstruction loss and a quantization loss. The system can minimize information loss by adjusting the weights of the deduplicator neural network 204 and reduplicator neural network 212 (to minimize reconstruction loss) and by updating the codebook vectors in the one or more codebooks (to minimize quantization loss) used by the tokenizer 206 and detokenizer 210.

In some implementation, the system trains the neural networks to minimize a reconstruction loss to encourage the networks to accurately recreate the input data and to preserve important features. The system also trains the neural networks on a quantization loss function. In particular, the system can learn the codebook vectors that minimize the quantization loss. The quantization loss measures an error introduced during the tokenization and detokenization steps, and ensures that the continuous representation, e.g., the combined encoding sequence 202, is accurately represented by the discrete representation 208.

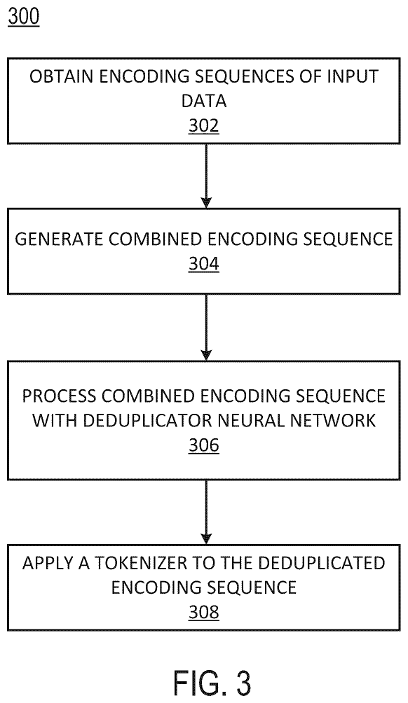

FIG. 3 is a flow diagram of an example process 300 for identifying a discrete representation of a combined encoding sequence. For convenience, the process 300 will be described as being performed by a system of one or more computers located in one or more locations. For example, a neural network training system, e.g., the neural network training system 100 depicted in FIG. 1, appropriately programmed in accordance with this specification, can perform the process 300.

The system obtains (302) more than one encoding sequence corresponding to an input data item. Each encoding sequence corresponds to a particular modality or a domain related to the input data item. In addition, each encoding sequence including a respective encoding vector at each position in the encoding sequence. For example, the encoding sequences can include a first encoding sequence for a dialogue audio component of the input data item, a second encoding sequence for a text component related to the input data item, and a third sequence for a music audio component related to the input data item.

As described in relation to FIG. 1, an encoding sequence includes an encoding vector at a sequence of positions. For example, the sequence of positions can correspond to time steps of an audio or video data stream. In some other examples, an encoding sequence can include positions that correspond to pixels of an image or a group of pixels of an image. In some other examples, an encoding sequence can include positions that correspond to word positions of a text document.

The system generates (304) a combined encoding sequence by, at each position, combining (i.e., stacking) the respective encoding vectors of the combined encoding sequence. As an illustrative example, consider a combined encoding sequence that includes N encoding sequences. Each encoding sequence includes T encoding vectors (e.g., T is the number of positions of an audio data item where an encoding vector is generated). Each encoding vector has dimensionality D, where D represents the number of features in each encoding vector. Therefore, each encoding sequence has a shape of [T, N*D]. In other words, the number of combined encoding vectors of the combined encoding sequence is the same as the number of encoding vectors in each respective encoding sequence. However, each vector in the combined encoding sequence has a dimensionality of N*D, where N is the number of encoding sequences and D is the dimensionality of each encoding vector.

In some implementations, the system resamples one or more encoding sequences before generating the combined encoding sequence to match a sampling rate of a particular encoding sequence. Each encoding sequence is sampled to include a same number of encoding vectors to combine the vectors at each sampled position.

The system processes (306) the combined encoding sequence using a deduplicator neural network to generate a deduplicated encoding sequence. The deduplicated encoding sequence includes a respective deduplicated encoding vector for each of the positions in the encoding sequence. A neural network system (i.e., the neural network system 200) trains the deduplicator neural network to remove redundant information between the more than one individual encoding sequences that are included in the combined encoding sequence. As previously described, the neural network training system trains the deduplicator neural network on a reconstruction loss that measures an error between the combined encoding sequence and the reconstruction of the combined encoding sequence.

The system applies (308) a tokenizer to the deduplicated encoding sequence to identify, for each deduplicated encoding vector, a discrete representation of the deduplicated encoding sequence. The tokenizer determines the discrete representation, as described in detail in relation to FIG. 2, from respective codebook vectors from each of a set of one or more codebooks. The system learns the codebook vectors during the training of the neural networks of the system. In some implementations, the system learns the codebook by minimizing a quantization loss function that evaluates how closely the set of codebook vectors represent input training data. In some implementations, a generative neural network processes the tokenized sequence (i.e., the sequence of vectors that includes the discrete representation of each deduplicated encoding vector) for generation of an output data item. For example, the generative neural network can be a large language model or any other set of one or more neural networks that processes a sequence of tokens or encodings as an input to generate a sequence of tokens or encodings as an output. Additionally, the system can store the tokenized sequence as a compressed representation of the input data item.

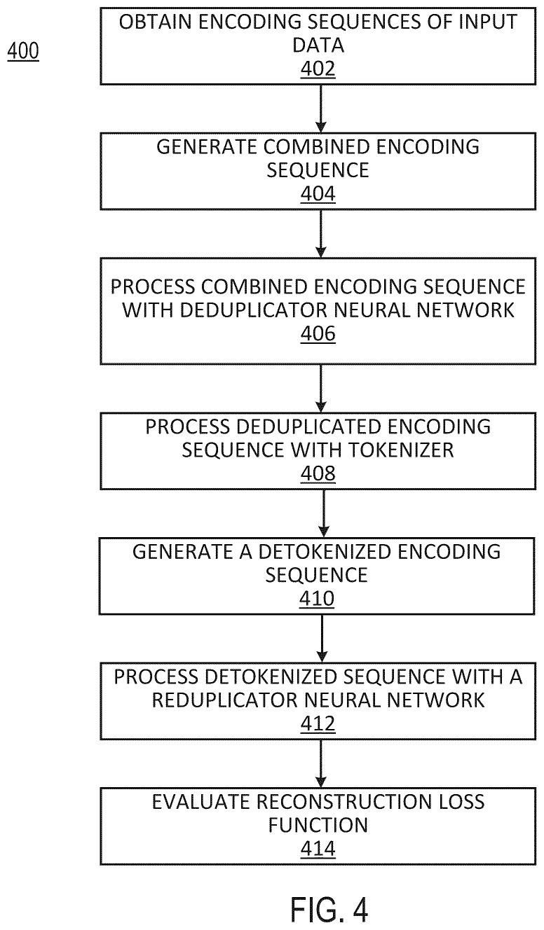

FIG. 4 is a flow diagram of an example process 400 for training a system of neural networks that includes a deduplicator neural network, a reduplicator neural network, a tokenizer, and a detokenizer. For convenience, the process 400 will be described as being performed by a system of one or more computers located in one or more locations. For example, a neural network training system, e.g., the neural network training system 100 depicted in FIG. 1, appropriately programmed in accordance with this specification, can perform the process 400. The system obtains (402) more than one encoding sequence corresponding to an input data item. Each encoding sequence corresponds to a modality or domain related to the input data item, and each encoding sequence includes a respective encoding vector at each position in the encoding sequence. Details of the combined encoding sequence are discussed in relation to FIG. 3.

The system generates (404) a combined encoding sequence by, at each position, combining (i.e., stacking) the respective encoding vectors at each position of the combined encoding sequence. Details of the combined encoding sequence are discussed in relation to FIG. 3.

The system processes (406) the combined encoding sequence using a deduplicator neural network to generate a deduplicated encoding sequence that includes a respective deduplicated encoding vector for each of the positions in the encoding sequence. Details of the deduplicator neural network are discussed in relation to FIG. 3.

The system applies (408) a tokenizer to the deduplicated encoding sequence to identify, for each deduplicated encoding vector, a discrete representation of the deduplicated encoding vector. The tokenizer determines the discrete representation, as described in detail in relation to FIG. 2, from respective codebook vectors from each of a set of one or more codebooks.

The system generates (410) a detokenized encoding sequence from the discrete representation generated by the tokenizer. The system identifies a codebook vector from the codebook used during tokenization. In some implementations, the system evaluates a quantization loss function by comparing the difference between the combined encoding sequence, e.g., before tokenization, and the detokenized encoding sequence, e.g., after detokenization. A mapping of a sequence of encoding vectors to a sequence of identifiers back to a sequence of encoding vectors includes loss of information because the set of discrete vectors of each codebook is finite. In some implementations, the system can update the one or more codebooks to minimize a quantization loss function. In other words, the system can update the one or more discrete sets of codebook vectors to better represent the combined encoding sequence.

The system processes (412) the deduplicated encoding sequence using a reduplicator neural network to generate a reconstruction of the combined encoding sequence. A neural network system (i.e., the neural network system 200) trains the reduplicator neural network to retain the redundant information that was removed by the deduplicator neural network. In some implementation, the system evaluates a reconstruction loss that evaluates a difference between an input combined encoding sequence processed by the deduplicator neural network and a reconstructed combined encoding sequence generated by the reduplicator neural network, as described below.

The system evaluates (414) a reconstruction loss that measures an error between the combined encoding sequence and the reconstruction of the combined encoding sequence. In some implementations, the reconstruction loss includes a respective reconstruction term for each encoding sequence that is indicative of an error between the encoding sequence and a portion of the reconstruction of the combined encoding sequence that corresponds to the encoding sequence. In other words, the reconstruction loss can include several terms, each term corresponding to a different encoding sequence for a different domain or modality. Furthermore, the system can apply a respective reconstruction loss for each encoding vector in the encoding sequence. Each respective reconstruction loss term depends on the relative importance of the respective encoding vector.

For example, to accommodate different degrees of importance placed on a first encoding sequence over a second encoding sequence, the reconstruction loss can be a weighted sum of the respective reconstruction terms, where two or more of the reconstruction terms have different weights in the weighted sum.

As another example, if the system determines the invertibility of the encoding sequence that represents the dialogue domain of an audio stream is more important than the invertibility of the encoding sequence that represents the environmental noise domain of the same audio stream, the system can assign a higher weight (i.e., higher importance) to the reconstruction loss corresponding to the encoding sequence that represents the dialog domain. As yet another example, if the system determines the invertibility of a first subset of the input encoding sequences (i.e., the beginning of an audio stream or a specific section of an image) is more important than the invertibility of a second subset of the input encoding sequences (i.e., the end of an audio stream or the edges of an image), the system can assign a higher weight (i.e., higher importance) to the reconstruction loss corresponding to the first subset of input encoding sequences.

In some implementations, the reconstruction term can measure a respective normalized reconstruction loss to correct for variations in scale of the one or more encoding vectors that are combined in the combined encoding sequence. The scale of encodings that represents different modalities or domains may be different which leads to an inadvertent unequal distribution of contributions to the reconstruction error. For example, the encoding vectors corresponding to environmental noise of an audio stream may have a different scale than the encoding vectors corresponding to the music of the same audio stream. In some cases, this may be appropriate, but to address the potential unwanted mismatch in scale, the neural network training system can normalize the reconstruction loss corresponding to a particular encoding sequence by dividing the reconstruction loss by a moving average of its L2-norm to improve scale invariance.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining a plurality of encoding sequences of an input data item, each encoding sequence comprising a respective encoding vector at each of a plurality of positions;
generating a combined encoding sequence by, at each position, combining the respective encoding vectors at the position in the plurality of encoding sequences;
processing the combined encoding sequence using a deduplicator neural network to generate a deduplicated encoding sequence that comprises a respective deduplicated encoding vector for each of the positions; and
applying a tokenizer to the deduplicated encoding sequence to identify, for each deduplicated encoding vector, a discrete representation of the deduplicated encoding vector generated from respective codebook vectors from each of a set of one or more codebooks, wherein each codebook is a respective discrete set of codebook vectors.

2. The method of claim 1, further comprising:
generating a tokenized sequence that identifies, for each deduplicated encoding vector, the respective codebook vectors from the set of one or more codebook vectors used to generate the discrete representation of the deduplicated encoding vector.

3. The method of claim 2, wherein, for each deduplicated encoding vector, the tokenized sequence comprises a respective identifier for each of the respective codebook vectors from the set of one or more codebook vectors used to generate the discrete representation of the deduplicated encoding vector.

4. The method of claim 2, further comprising:
providing the tokenized sequence as input to a generative neural network for generation of an output data item.

5. The method of claim 2, further comprising:
compressing the tokenized sequence to generate compressed data; and
storing the compressed data as a compressed representation of the input data item.

6. The method of claim 1, further comprising:
generating a detokenized sequence that comprises respective quantized representations of each of the deduplicated encoding vectors; and
processing the detokenized sequence using a reduplicator neural network to generate a reconstruction of the combined encoding sequence.

7. The method of claim 6, further comprising:
training the reduplicator neural network and the deduplicator neural network on a loss function that comprises a reconstruction loss that measures an error between the combined encoding sequence and the reconstruction of the combined encoding sequence.

8. The method of claim 7, wherein the reconstruction loss comprises a respective reconstruction term for each encoding sequence that measures an error between the encoding sequence and a portion of the reconstruction of the combined encoding sequence that corresponds to the encoding sequence.

9. The method of claim 8, further comprising:
wherein each reconstruction term measures a respective normalized reconstruction loss to correct for variations in scale of the one or more encoding vectors.

10. The method of claim 8, wherein the reconstruction loss is a weighted sum of the respective reconstruction terms, and wherein two or more of the reconstruction terms have different weights in the weighted sum.

11. The method of claim 7, further comprising:
updating the one or more codebooks on a quantization loss function.

12. The method of claim 9, further comprising:
applying a respective reconstruction loss for each encoding vector, wherein the respective reconstructive loss depends on the relative importance of the respective encoding vector.

13. The method of claim 1, wherein the input data item comprises multiple modalities of data, and the plurality of sequences include a respective encoding sequence for each of the multiple modalities.

14. The method of claim 1, wherein combining the respective encoding vectors comprises combining the respective encoding vectors at the position in the plurality of encoding sequences.

15. The method of claim 1, further comprising:
generating each encoding sequence using a respective encoding neural network.

16. A system comprising one or more computers and one or more storage devices storing instructions that when executed by the one or more computers cause the one more computers to perform operations comprising:
obtaining a plurality of encoding sequences of an input data item, each encoding sequence comprising a respective encoding vector at each of a plurality of positions;
generating a combined encoding sequence by, at each position, combining the respective encoding vectors at the position in the plurality of encoding sequences;
processing the combined encoding sequence using a deduplicator neural network to generate a deduplicated encoding sequence that comprises a respective deduplicated encoding vector for each of the positions; and
applying a tokenizer to the deduplicated encoding sequence to identify, for each deduplicated encoding vector, a discrete representation of the deduplicated encoding vector generated from respective codebook vectors from each of a set of one or more codebooks, wherein each codebook is a respective discrete set of codebook vectors.

17. The system of claim 16, the operations further comprising:
generating a tokenized sequence that identifies, for each deduplicated encoding vector, the respective codebook vectors from the set of one or more codebook vectors used to generate the discrete representation of the deduplicated encoding vector.

18. The system of claim 17, wherein, for each deduplicated encoding vector, the tokenized sequence comprises a respective identifier for each of the respective codebook vectors from the set of one or more codebook vectors used to generate the discrete representation of the deduplicated encoding vector.

19. The system of claim 17, the operations further comprising:
providing the tokenized sequence as input to a generative neural network for generation of an output data item.

20. One or more computer readable storage media storing instructions that when executed by one or more computers cause the one more computers to perform operations comprising:
obtaining a plurality of encoding sequences of an input data item, each encoding sequence comprising a respective encoding vector at each of a plurality of positions;
generating a combined encoding sequence by, at each position, combining the respective encoding vectors at the position in the plurality of encoding sequences;
processing the combined encoding sequence using a deduplicator neural network to generate a deduplicated encoding sequence that comprises a respective deduplicated encoding vector for each of the positions; and
applying a tokenizer to the deduplicated encoding sequence to identify, for each deduplicated encoding vector, a discrete representation of the deduplicated encoding vector generated from respective codebook vectors from each of a set of one or more codebooks, wherein each codebook is a respective discrete set of codebook vectors.
